(19) United States
(12) Patent Application Publication
(10) Pub. No.: US 2026/0047526 A1
(43) Pub. Date: Feb. 19, 2026

(54) ELECTRICALLY DRIVEN AGRICULTURAL PLATFORM

(71) Applicant: GTS DO BRASIL LTDA., Lages (BR)

(72) Inventor: Assis STRASSER, Lages (BR)

(21) Appl. No.: 19/102,994

(22) PCT Filed: Aug. 9, 2023
(86) PCT No.: PCT/BR2023/050255

§ 371 Date: Feb. 11, 2025

(30) Foreign Application Priority Data
Aug. 11, 2022 (BR) 1020220158916

(51) Int. Cl. A01D 47/00; A01D 41/127; A01D 45/02; A01D 69/02

(52) U.S. Cl. CPC A01D 47/00; A01D 41/1274; A01D 45/021; A01D 69/02

(57) ABSTRACT

An electrically driven agricultural harvesting platform (1) that replaces commonly known platforms that use mechanical power transmission. The use of an electric drive guarantees better efficiency during harvesting processes, which is carried out through an assembly of interconnected elements comprising: a generator (4), a control module (5) that drives and controls additional elements such as motors (8) and a platform sensor (6) that are connected by means of cables (7) that send logical and power information between the different elements.

### FIELD OF THE INVENTION

The present invention pertains to the field of agricultural machinery, more specifically in the field of developing grain harvesting platforms, and describes an electrically driven agricultural harvesting platform.

### BACKGROUNDS OF THE INVENTION

Agriculture is an economic activity and an important productive sector; therefore, such an activity holds great interest from all types of people and companies. This interest also includes developing and promoting the evolution and optimization of the techniques and equipment involved in all steps of the process, from planting to harvesting, with the aim of increasing and improving the production.

In this way, technological advances have allowed many techniques and machines to be created and improved, which has ensured better performance in various practices of the agricultural activity. Specifically, the currently used machines have replaced the professional who manually performed the steps of the production, such as harvesting, making it more efficient and faster.

These machines responsible for harvesting essentially comprise platforms responsible for cutting and harvesting the cultivated crop. They have the capacity to receive the crop, separate the product with economic value (for example, the grains) from the disposable material (for example, the straw) and store the product.

The harvesters have, at the front, a feeding channel in which the harvested material is introduced. The cutting platform, adapted to the type of harvested crop, is attached to the feeding channel, which platform cuts and transports the crop to the feeding channel of the harvester.

The feeding channel of the harvester also has, on its sides, transmission shafts that are connected to cardan shafts of the agricultural platform, in which the rotational movement of the transmission shafts of the harvester is transmitted to the cardan shafts of the agricultural platform, which, in turn, is multiplied and reduced by chains and shafts that drive the transmission boxes of the harvesting lines and feeder worm, thus driving and operating the agricultural platform with the mechanical transmission coming from the harvester. The mechanical movement transmission system is commonly used in the agricultural platforms and all these drives require the movement of several elements, which results in inertia and mass.

### STATE OF THE ART

Document EP1935226 presents a drive for the cutting system of an agricultural platform in which one of the possibilities of the drive is to be configured with the presence of an electric motor. The document does not present a solution for the electrical drive of the other elements of the agricultural platform, as the present invention, only for the cutting system of the platform.

Document U.S. Pat. No. 8,931,245 describes an individual electric drive system for cutting discs that allows the individual adjustment of the speed and/or direction of rotation of each cutting disc. The document does not present a solution for the electric drive of the other elements of the agricultural platform, such as the present invention, only for the cutting system of the platform.

There is no document in the patent literature that presents an electric drive system for an agricultural platform that controls and monitors the cutting system, harvesting lines, height sensor and feeder worm, according to the present invention.

### BRIEF DESCRIPTION OF THE INVENTION

The present invention presents an electrically driven agricultural platform (1), which drives and controls the other elements contained in the platform, such elements being responsible for the most varied functions, from cutting, harvesting and moving the grains to the interior of the harvester. Such a platform is preferably used in agricultural crop platforms such as corn, in this example, or other types of grains.

The present invention replaces the agricultural harvesting platforms that use the commonly used mechanical transmission system and comprises, in one of its preferred configurations, an agricultural harvesting platform comprising harvesting lines (2) and a feeder worm (3), a generator (4), at least one control module (5), a height sensor (6) and a plurality of electric motors (8).

### BRIEF DESCRIPTION OF THE FIGURES

In order to obtain a complete and total view of the object of this invention, the figures to which references are made are presented, as follows.

FIG. 1 shows the complete harvesting platform.

FIG. 2 shows the complete harvesting platform in a bottom view.

FIG. 3 shows the electric drive system assembled with the electric motors, worm motors, ECU, height sensor and generator.

FIG. 4 shows the electric drive system assembled on the platform with the main drive items such as the harvesting lines, the feeder worm and the generator.

FIG. 5 shows the detail of the feeder worm with its respective motor.

FIG. 6 shows the ECU and height sensor assembled.

FIG. 7 shows the electric motor assembled on the harvesting line with the power and logic cable.

FIG. 8 shows a typical configuration of a mechanical harvesting line assembly.

FIG. 9 shows the chain drive gear of the worm.

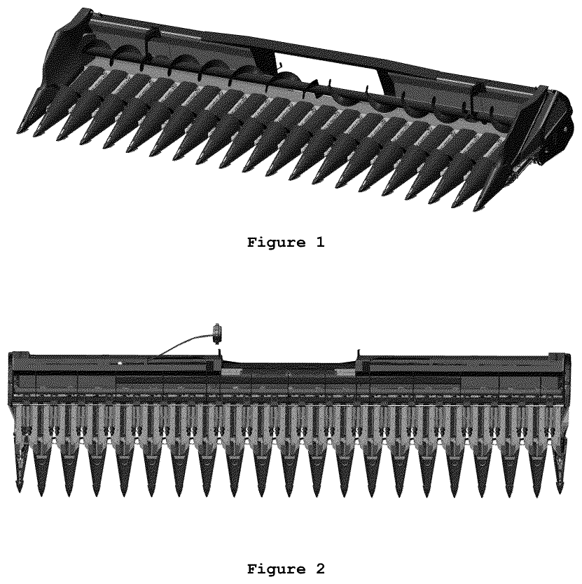

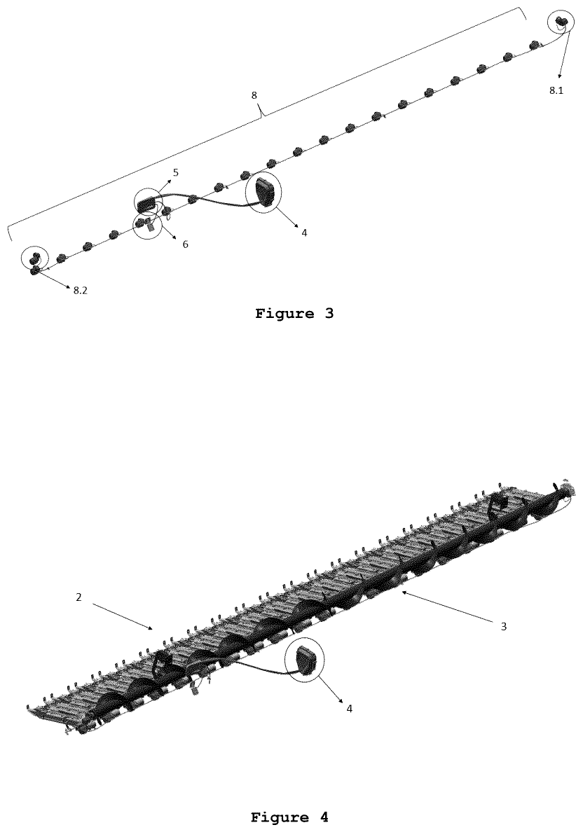

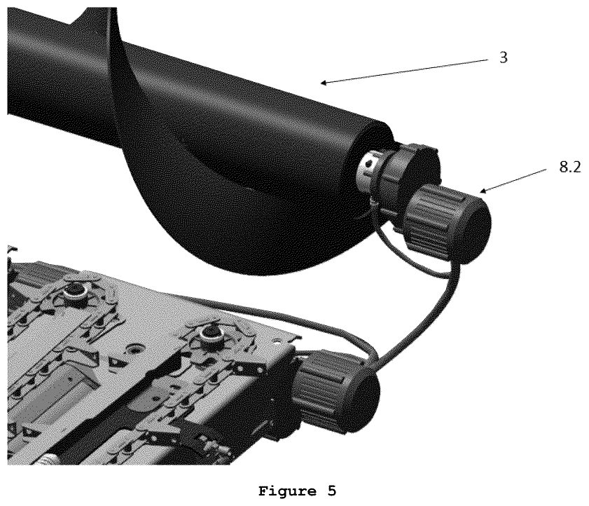

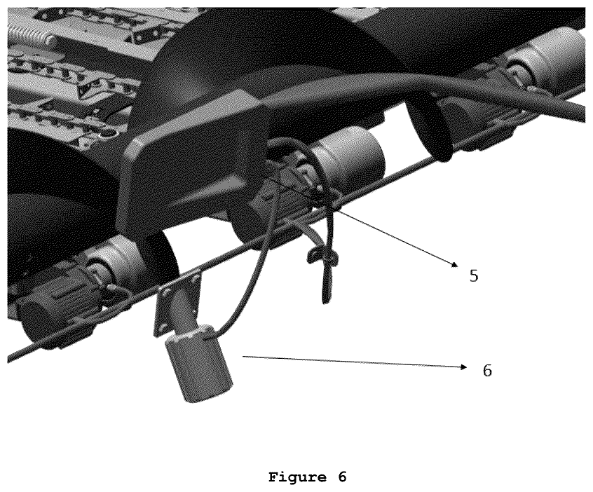

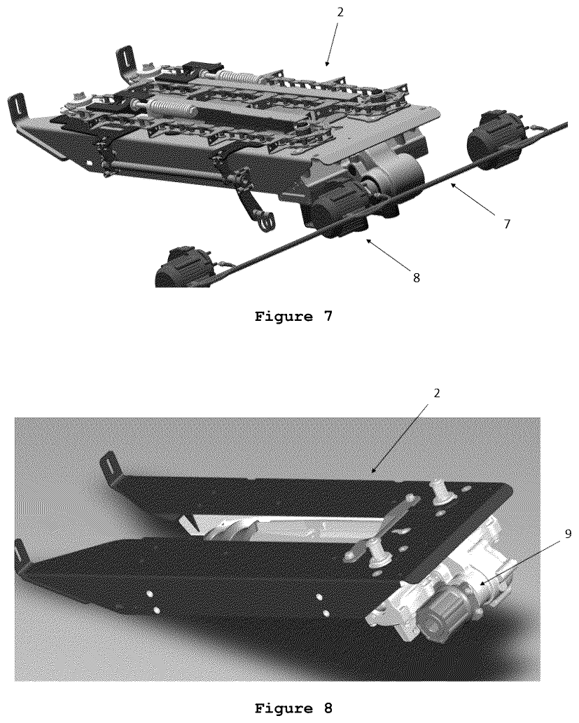

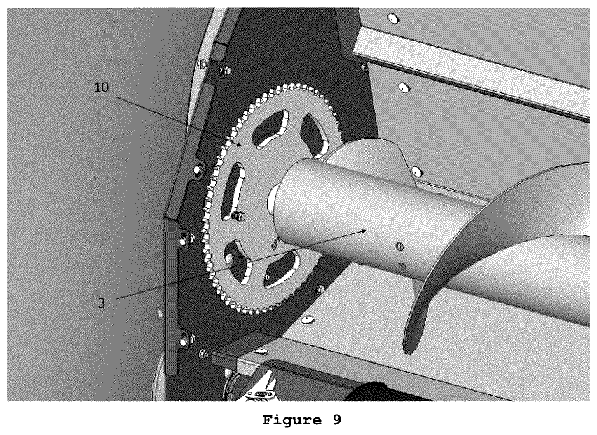

### DETAILED DESCRIPTION OF THE INVENTION

The present invention presents a corn harvesting platform (1) with electrical drives of the harvesting lines (2) and the feeder worm (3). The presence of the electrical drive system present in the platform replaces the usually used mechanical transmission method.

The harvesting lines (2) are used to receive the crop on which the machinery is operating, in this case, corn. The harvesting lines have belts, plates, rollers and helicoids for the correct extraction of the cobs and disposal of the straw during the harvesting process.

The feeder worm (3) has the function of moving the grains harvested by the harvesting lines (2) towards the center of the platform, so that they can be stored. It is worth mentioning that the feeder worm (3) has motors (8.1 and 8.2) attached to its ends that ensure the power supply for its movement.

These elements are powered by a generator (4) to electrically supply the other elements, to which the harvester power take-off is directly coupled. Such a coupling ensures that, with the rotation of the transmission shaft of the harvester, the mechanical energy is transformed into electrical energy and directed to the control module (5).

The control module (5) receives information about the platform through sensors, such as the height sensor (6), and from the cables (7) that carry logical information to the control module (5). Accordingly, the control module (5) uses such information to better control and power the parts under its influence, such as the motors (8). It is worth highlighting that the control module (5) is capable of independently controlling each motor (8), including the right and left worm motors (8.1 and 8.2) responsible for the rotation of the feeder worm (3).

The height sensor (6) represents the possibility of adding readings of parameters of interest to the system, in addition to enabling the height of the platform in relation to the ground to be completely automatically adjusted.

The height sensor (6) performs the function of capturing the height of the platform during its operation and providing information to the control module (5), so that new adjustments, configurations or decision-making can be performed, such as height adjustment.

The interconnection between the motors, the generator (4), the control module (5) and the sensor (6) is carried out by means of cables (7) suitable for the application with coupled power and logic.

The motors (8) have the function of moving the other elements of the harvesting platform that will cut and harvest the agricultural crop in question. Such motors are coupled to the mechanical clutches (9) that will be responsible for moving each harvesting line (2) existing on the harvesting platform.

On the other hand, the feeder worm motors (8.1 and 8.2) are motors of the same nature as the motors (8); however, they are responsible for moving the feeder worm (3). Such a movement is carried out by the aforementioned motors (8.1 and 8.2) that move the worm through the worm drive gear (10) contained inside the platform.

In addition, all motors (8, 8.1 and 8.2) and the generator (4) have a logic system coupled, the electronic module (5), to control and collect possible data such as speed, torque, temperature and voltage of the elements.

Therefore, the corn electrically driven harvesting platform proposed by the present invention portrays the benefit of having an electrical drive instead of using a purely mechanical one.

Those skilled in the art will value the knowledge presented herein and will be able to reproduce the invention in the presented embodiments and in other variants, encompassed by the scope of the attached claims.

1. An electrically driven agricultural platform, wherein the elements of the platform responsible for extracting and harvesting the agricultural crop are electrically driven, which comprises:
a harvesting platform (1);
harvesting lines (2);
a feeder worm (3);
a generator (4);
a control module (5);
at least one sensor (6);
cables (7);
a plurality of motors (8); and
mechanical clutches (9).

2. The platform according to claim 1, wherein the harvesting platform (1) is responsible for extracting, harvesting and moving the corn agricultural crop.

3. The platform according to claim 1, wherein the harvesting lines (2) are coupled to the motors (8) and receive the crop and comprise belts, plates, rollers and helicoids.

4. The platform according to claim 1, wherein the feeder worm (3) is connected to the motors (8.1 and 8.2) and moves the crop harvested by the harvesting lines (2) towards the center of the platform (1).

5. The platform according to claim 1, wherein the generator (4) is coupled to the power take-off and is responsible for electrically supplying the other elements, in which the generator (4) is connected to the transmission shaft of the feeding channel of the harvester, transforms the mechanical energy supplied by the transmission shaft into electrical energy, and transmits the electrical energy generated to the control module (5).

6. The platform according to claim 1, wherein the control module (5) is supplied by the generator (4), receives information about the platform through the sensors (6) and cables (7), in which the control module (5) uses such information to control and supply power to the parts under its influence, such as the motors (8).

7. The platform according to claim 1, wherein the control module (5) is capable of independently controlling each motor (8), including the right and left worm motors (8.1 and 8.2) responsible for the rotation of the feeder worm (3).

8. The platform according to claim 1, wherein the sensor (6) is a height sensor that provides information to the control module (5) to adjust the height of the platform in relation to the ground.

9. The platform according to claim 1, wherein the cables (7) carry logical information to the control module (5) and interconnect the motors (8), the generator (4), the control module (5) and the sensor (6) at the power and logical level.

10. The platform according to claim 1, wherein the motors (8) move the other mobile elements of the harvesting platform responsible for cutting and harvesting the agricultural crop, in which the motors (8) are coupled to the mechanical clutches (9) responsible for moving each harvesting line (2).

11. The platform according to claim 10, wherein the motors of the feeder worm (8.1 and 8.2) are motors of the same nature as the motors (8), responsible for moving the feeder worm (3) through the worm drive gear (10).

12. The platform according to claim 10, wherein the feeder worm (3) is coupled to motors (8.1 and 8.2) at its ends that guarantee the supply of energy for its movement.

13. The platform according to claim 1, wherein the mechanical clutches (9) are coupled to the motors (8) that will be responsible for moving each harvesting line (2) existing in the harvesting platform.

14. The platform according to claim 1, wherein the motors (8) and the generator (4) are coupled to the electronic module (5), capable of collecting data such as speed, torque, temperature and voltage of the elements and controlling the motors (8).
